(19) United States
(12) Patent Application Publication
(10) Pub. No.: US 2006/0061985 A1
(43) Pub. Date: Mar. 23, 2006

(54) Drinking vessel with auditory and visual stimulation

(76) Inventor: John Elkins, Park City, UT (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/948,380

(22) Filed: Sep. 23, 2004

(51) Int. Cl. F21V 33/00

(52) U.S. Cl. 362/101; 362/253

(57) ABSTRACT

A drinking vessel includes a vessel for containing a liquid and an electronic unit for attachment to the vessel. The electronic unit is configured to emit both light and sound to stimulate a child using the drinking vessel. The electronic unit configured for attachment to a drinking vessel includes a speaker for emitting sounds; a memory for storing recorded sounds for playback using the speaker; and a housing containing the speaker and memory. The housing including means for attaching the housing to the drinking vessel.

### BACKGROUND

The objects and toys given to an infant or child can have a significant impact on that child. For example, studies have shown that the involvement of music, particularly classical music, in a child's first years can play a key role in that child's physical and mental development. Similar studies have indicated that visual stimulation is also important for a child's development.

Consequently, products for infants and children have been developed that seek to provide advantageous stimulation, either auditory or visual. For example, collections of classical music have been prepared and marketed specifically for infants and young children. Arrangements of poetry designed to be read to young children have also been prepared. Products that can stimulate a young child's auditory or visual senses are quite popular.

### SUMMARY

A drinking vessel includes a vessel for containing a liquid and an electronic unit for attachment to the vessel. The electronic unit is configured to emit both light and sound to stimulate a child using the drinking vessel.

The electronic unit configured for attachment to a drinking vessel includes a speaker for emitting sounds; a memory for storing recorded sounds for playback using the speaker; and a housing containing the speaker and memory. The housing including means for attaching the housing to the drinking vessel.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is an illustration of an assembled baby bottle according to principles described herein.

FIG. 2 is an illustration of the baby bottle of FIG. 1 after disassembly.

FIG. 3 is a diagram of the principal electronic components of the baby bottle of FIG. 1.

FIG. 4 is another illustration of the principal electronics of the baby bottle of FIG. 1 in a housing configured for attachment to the baby bottle.

FIG. 5 is an illustration of the assembled baby bottle of FIG. 1 with the light operating.

FIG. 6 is an illustration of a toddler cup according to principles described herein.

Throughout the drawings, identical reference numbers designate similar, but not necessarily identical, elements.

### DETAILED DESCRIPTION

A Musical/Glow Baby Bottle and Toddler Cup are described below. These products combine the use of light with soothing sounds, such as classical music, nursery rhymes, lullabies or the sounds of a parent's voice or heartbeat to comfort and stimulate a child's visual and auditory senses. This stimulation promotes cognitive development during feeding, nap time or throughout the day.

As used herein and in the appended claims, the term “drinking vessel” is used to refer broadly to any object used to contain liquid for consumption by a person, for example, an infant or young child. Thus, examples of a drinking vessel including a baby bottle and a toddler cup, a soda can or bottle, a glass or novelty cup. Also, as used herein and in the appended claims, the term “vessel” is used to refer specifically to that portion of a drinking vessel that actually contains liquid or houses a bag or liner filled with liquid.

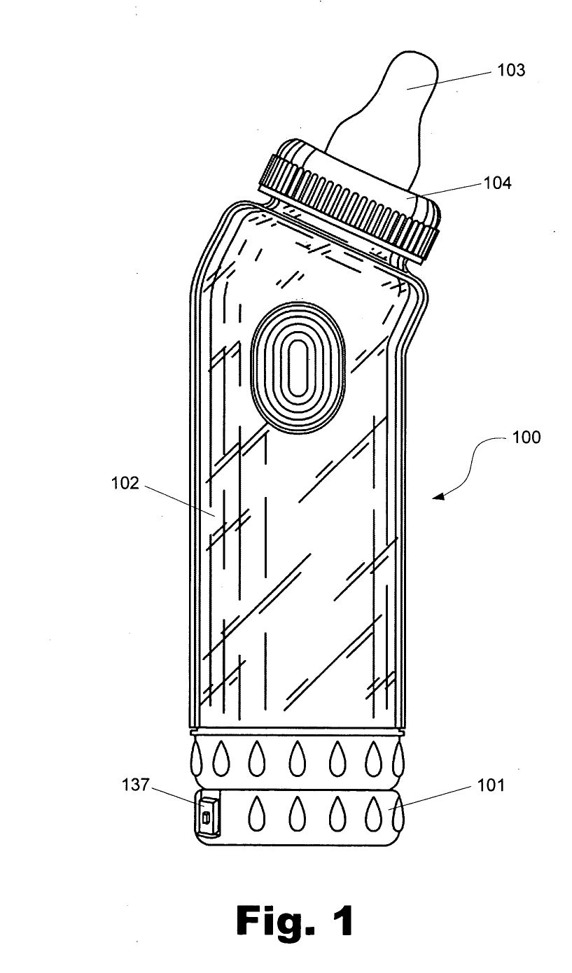

FIG. 1 is an illustration of an assembled baby bottle (100) according to principles described herein. As shown in FIG. 1, the baby bottle (100) includes a vessel (102). The vessel (102) is translucent, meaning that light passes through at least portions of the structure of the vessel. For example, the vessel (102) may be formed partially or entirely of a clear or color-tinted plastic.

When the bottle (100) is in use, the vessel (102) may directly contain fluid for consumption by an infant. Alternatively, the vessel (102) may house a plastic liner or bag that contains the fluid for consumption.

At the top of the vessel (102), a rubber nipple (103) is placed in fluid communication with the vessel (102) to allow an infant to suck the fluid from the vessel (102). A threaded retaining ring (104) secures the nipple (103) to the vessel (102). In the illustrated example, the upper end of the vessel (102) includes threads for receiving the retaining ring (104). The retaining ring (104) also includes threads which are mated with the treads of the vessel (102) when the retaining ring (104) is screwed onto the vessel (102).

At the bottom of the vessel (102), an electronic unit (101) is also attached to the bottle (100). The electronic unit (101), as will be described in detail below, can provide both light and sound to stimulate an infant who is drinking from the bottle (100). The electronic unit (101) can selectively produce light, sound or both light and sound. The electronic unit (101) may be attached to the vessel (102) by screwing together threads on the electronic unit (101) and threads of the vessel (102).

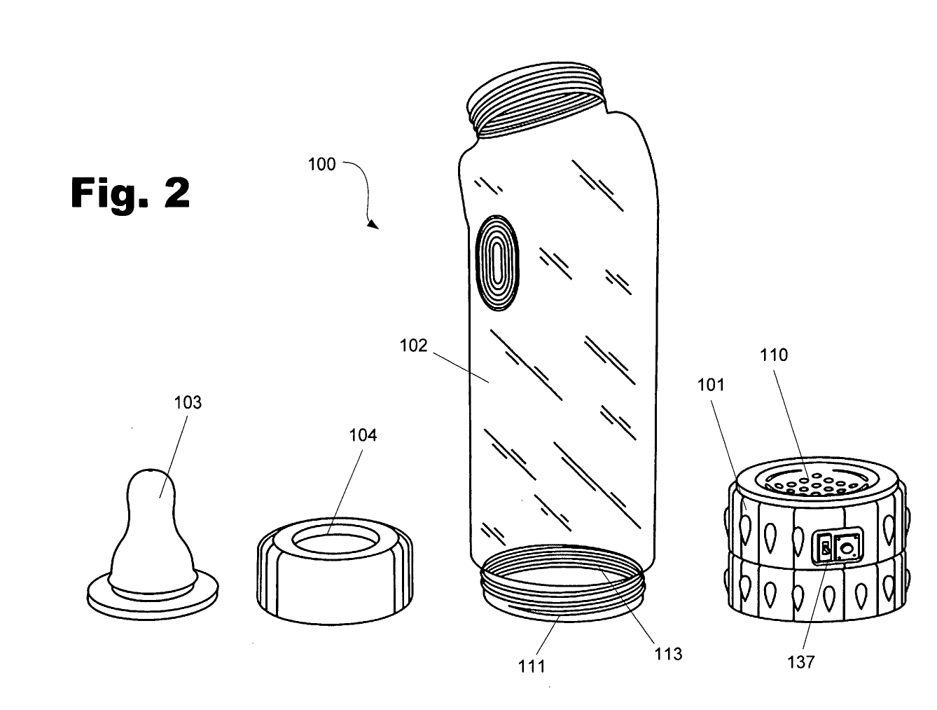

FIG. 2 is an illustration of the baby bottle of FIG. 1 after disassembly. If the vessel (102) is designed to be directly filed with fluid, the vessel will include a translucent bottom (113) adjacent to the electronic unit (101) and through which the electronic unit (101) shines its light. In such a case, the threads (111) on the vessel (102) for attaching the electronic unit (101) are exterior to the vessel (102) and are located on an extension that extends below the translucent vessel bottom (113).

If the vessel (102) is configured to contain a liner or bag filled with fluid, the end of the vessel (102) may be open with threads (111) at the end for receiving the electronic unit (101). Alternatively, the vessel (102) may have the translucent bottom and threads as described above and still be configured to contain a liner filed with fluid. The threaded portion (111) of the vessel (102) may be male or female with respect to the electronic unit (101).

Some additional details of the electronic unit (101) are also shown in FIG. 2. For example, the end of the electronic unit (101), opposite the threaded end attached to the vessel (102), may include a gill (110) formed, for example, of molded plastic. The speaker (described below) of the electronic unit (101) is positioned at the grill (110) so that the electronic unit (101) can readily emit sounds for an infant who is drinking from the bottle (100). As noted above, these sounds may be, for example, music, nursery rhymes, a parent or family member's voice, etc.

User controls (137), which will be described in more detail below, are also provided to control the electronic unit (101). The user controls (137) can, for example, be used to adjust the volume of sound emitted from the electronic unit (101); adjust whether light, sounds or both are emitted; set a timer for the light, sound or both; record sounds for later playback, etc.

In the illustrated example, the baby bottle (100) is a standard plastic bottle design with a fully enclosed, translucent bottom (113). The vessel (102) is roughly 5 inches in depth and 2 2/16 inches wide at the bottom (113). The vessel (102) also has as an additional ½ inch extension below the vessel bottom (113) for supporting the screw threads (111) on which the electronic unit is attached. This extension is, for example, 1¾ inches wide.

The vessel (102) also includes an extension of, for example, ½ inch around the open neck of the vessel (102) to support screw threads for mating with the nipple retaining ring (104). This extension is, for example, 1⅜ inches wide, bringing the total vessel height to roughly 6 inches.

In addition to the 6 inch vessel height, the retaining ring (104) measures, for example, ¾ inches high by 1¾ wide, with a 1½ inch high silicone nipple that would bring the total bottle height to roughly 7¼ inches without the electronic unit (101) being attached. The electronic unit (101) measures, for example, 2 2/16 inches wide by 1 inch high bringing the total bottle height in the illustrated example to roughly 7¾ inches with the electronic unit (101) attached.

It should be understood that all dimensions given herein are merely exemplary. Various embodiments of the products described herein are not limited to the described dimensions.

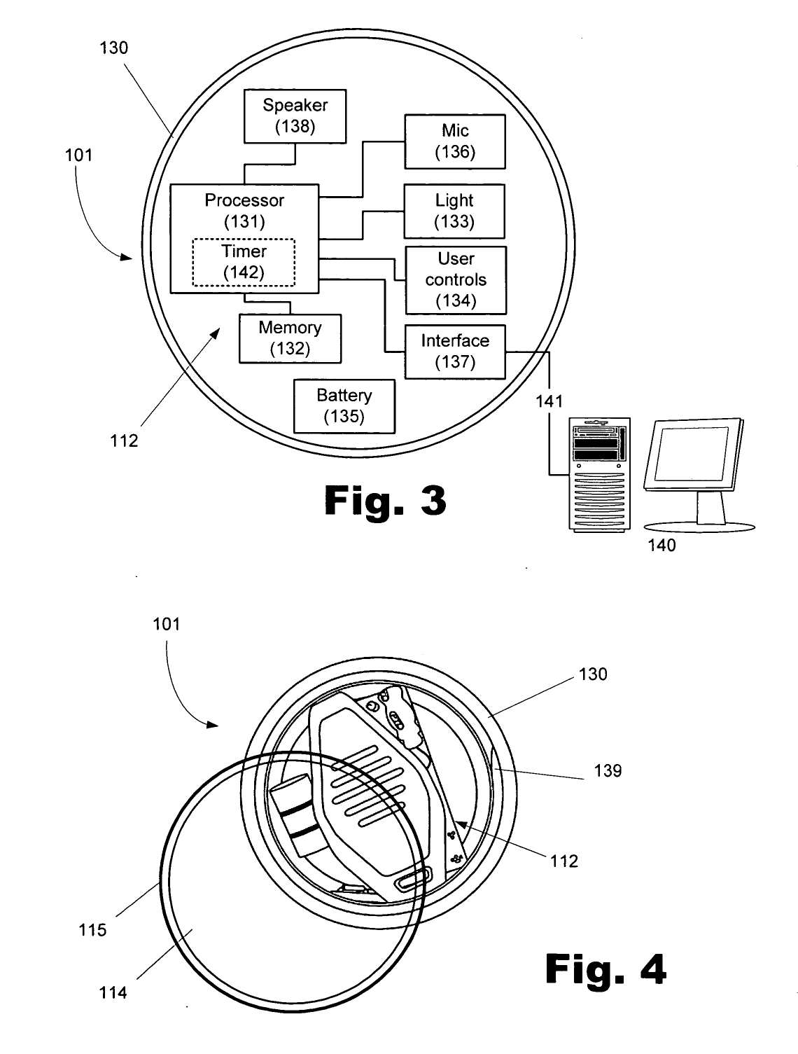

FIG. 3 is a diagram of the principal electronic components (112) of the electronic unit (101) of FIG. 1. As shown in FIG. 3, the electronic unit (101) includes a number of electronic components (112) disposed in a housing (130). The housing (130) may be plastic or other material and is of a generally circular shape. The housing (130) is designed to be attached to the bottle (100) shown in FIGS. 1 and 2 or to some other drinking vessel.

As shown in FIG. 3, the electronics (112) of the unit (101) include a speaker (138) from which the unit (101) reproduces recorded sounds. The recorded sounds are stored, for example, digitally in a memory unit (132). The memory unit (132) can be volatile or non-volatile. In some examples, non-volatile, Flash memory is used as the memory unit (132).

A processor (131) controls the electronic unit (130) including the playback of recorded sounds from the memory unit (132). In some examples, the processor (131) and memory unit (132) may be integrated into a single device or chip. A single integrated circuit (IC) may provide both the processor and associated memory.

An interface (137) may be provided to allow the electronic unit (101) to communicate with other electronic devices, such as a personal or host computer (140). The interface (137) can be a wired or wireless interface. FIG. 3 illustrates an interface (137) that is a connector for receiving a wired connection (141) between the electronic unit (101) and a host computer (140).

Through the interface (137, 141), sound recordings or audio data can be downloaded into the memory unit (132) for subsequent playback by the electronic unit (101). The recordings may be stored in any format, including compressed formats, such as MP3 (Motion Picture Expert Group, Layer 3). Other recording formats that may be supported include for example, WAV, PCM, WMA, ALF2, ADPCM, GSM, DSP, a-law, U-law, VOX (dialogic ADPCM), raw (PCM, a-law, U-law), OGG VORBIS.

In some examples, a microphone (136) is also provided in the electronic unit (130). Using the microphone (136), a user can record sounds to the memory unit (132) for subsequent playback. Thus, the user can record any sounds desired on the electronic unit (101) for playback to an infant using the bottle (100, FIG. 1). Such sounds may include, for example, a person speaking or reading, a heart beat, a person singing, etc. The microphone (136) transduces the actual sound into electronic audio data that is then recorded on the memory unit (132).

The electronic unit (101) also includes a light course (133) that is illuminated to visually stimulate an infant using the bottle (100, FIG. 1). This light (133) may include, for example, a light bulb or light emitting diode (LED). As will be described in more detail below, in some examples, this light source (133) is used to shine a light or lights into a fluid in the translucent vessel of the drinking vessel to which the electronic unit (101) is attached. This produces the desired “glow” about the drinking vessel for the advantageous stimulation of a child drinking from the drinking vessel.

The light source (133) may be a white or colored light source or may include lights of a variety of colors. The various lights of the light source (133) may be switched on and off during operation to further stimulate a child using the drinking vessel. Such operation of the lights may or may not be synchronized with sound also being produced by the electronic unit (101). The processor (131) may be programmed to so control the lights of the light source (133) and the audio output of the electronic unit (101).

As shown in FIG. 3, the electronic unit (101) may also include a timer (142). The timer (142) may be integrated with, or a function of, the processor (131). The timer (142) can be set to automatically turn of the sound playback and/or the light source (133) after a specified period of time, for example, 30 or 60 minutes.

The timer (142) can operate the sound playback and light source independently. For example, the timer (142) may control the light (133) to turn off after a first period of time, but sound playback may then continue for another period of time, or vice versa.

User controls (134) are also provided to allow a user to control the electronic unit (101). The user controls (134) may include, for example, switches, buttons, dials, knobs, etc. The user controls (134) may also include a display device. The user controls (134) can include any components to allow a user to control the features of the electronic unit (101). For example, the user controls (134) can be used to initiate, pause or stop playback of sounds recorded in the memory unit (132); turn the light source (133) on and off; adjust the volume of the sound produced by the electronic unit (101); and set a timer (142) for either or both the light and sound produced by the unit (101).

Finally, one or more batteries (135) are included to provide power to the various components (112) of the electronic unit (101). All the components (112) may be powered from a single battery or different batteries may be included for powering one or more separate components.

For example, the processor (131), memory (132) and speaker (138) may be powered by a first battery or set of batteries, for example, 3 PCS L1154 batteries or a single AAA battery. The light (133) may be powered a separate PCS L1154 battery.

FIG. 4 is another illustration of the principal electronics of the electronic unit for attachment to the baby bottle of FIG. 1. As shown in FIG. 4, the electronics (112) are disposed in a housing configured for attachment to the baby bottle. In the illustrated example, the housing (130) includes threads (139) for connecting the electronic unit (101) to the baby bottle (100, FIG. 1).

As shown in FIGS. 2 and 4, the electronic unit (101) can be detached from the bottle (100) and could then be used separately as a portable audio unit. A cover (114) may be provided with the electronic unit (101) that can be secured over the electronics (112) of the unit (101) when the unit (101) is not attached to a bottle (100). This cover (114) may be translucent and can provide access to the electronics (112) for purposes of changing the batteries (135), etc. The cover (114) may have threads (115) that match the threads (139) of the housing (130) so that the cover can be screwed onto and close the housing (130).

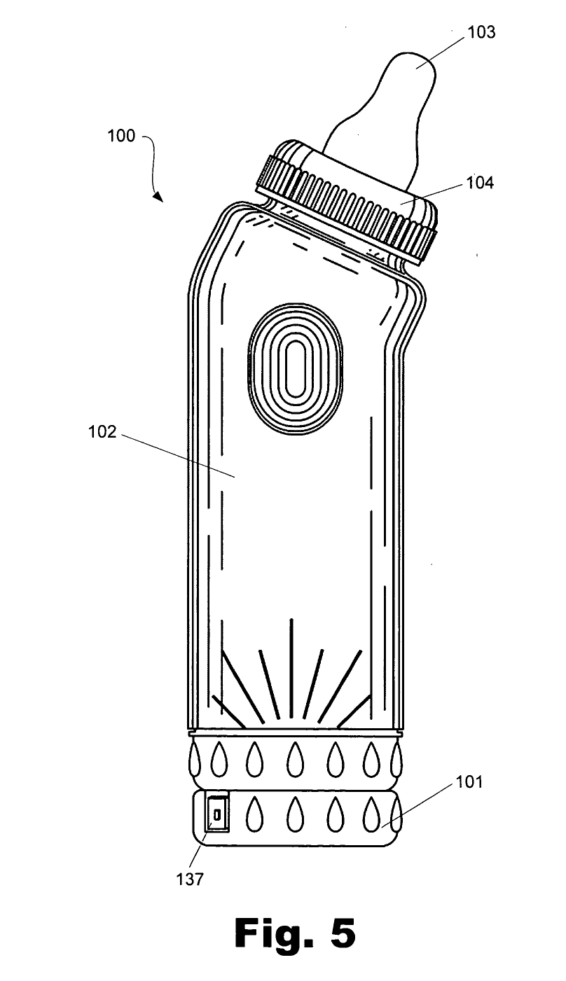

FIG. 5 is an illustration of the assembled baby bottle of FIG. 1 with the light operating. As shown in FIG. 5, the light from the electronic unit (101) will shine up into the vessel (102). Any fluid in the vessel (102) and the structure of the vessel (102) will tend to randomly disperse or diffuse the light from the light source (133) in the electronic unit (101). This provides a pleasant glow about the bottle (100) that will be pleasing and stimulating to an infant. This effect will be enhanced in the dark or in low ambient light conditions.

Additionally, if the bottle (100) is dropped by the infant in a dark place, the glow from the electronic unit (101) will make it easier to locate and retrieve the bottle (100). This applies to either the infant or a care-giver supervising the infant.

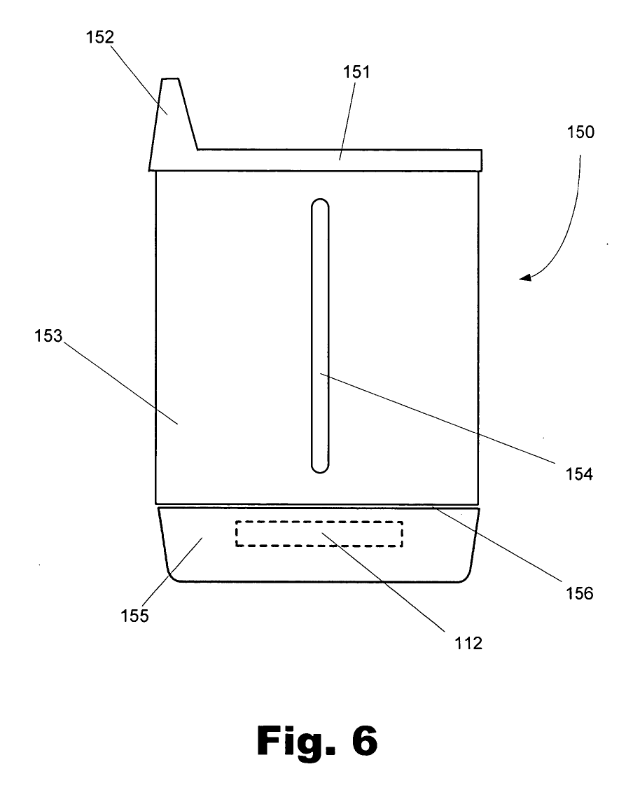

FIG. 6 is an illustration of another drinking vessel, a toddler cup, according to principles described herein. As shown in FIG. 6, an electronic unit (155) similar to that described above, can be attached to a toddler cup (150) rather than to an infant's bottle.

The toddler cup or “sippy cup” (150) includes a vessel (153) for containing liquids. Like the vessel (102) of the bottle described above, the vessel (153) of the toddler cup (150) will be at least partially translucent and may be formed of a clear or color-tinted plastic.

A lid (151) with a drinking spout (152) may be attached over the top of the vessel (153). In some examples, the drinking spout may be replaced by a nipple, similar to the nipple illustrated and described above. The lid (151) may be snapped to the vessel (153) or may be threaded and screwed onto matching threads on the vessel (153).

A handle (154) or pair of handles may be provided on the sides of the toddler cup (150). In some examples, a handle (154) is provided on each side of the vessel (153) to allow a child to grip the cup (150) with both hands.

An electronic unit (155), containing some or all of the same principal electronic components (112) described above, is attached to the bottom (156) of the cup vessel (153). As above, the electronic unit (155) may include a threaded housing that is screwed onto threads providing at the bottom of the vessel (153). The bottom (156) of the vessel (153) will be translucent so as to allow light from the electronic unit (155) to shine up into the liquid in the vessel and be diffused by the liquid and the structure of the cup vessel (153). This will create a pleasant glow about the cup (150) in the same manner described above.

The electronic unit (155) will also include the user controls, memory and speaker described above. Thus, the electronic unit (155) provides the same light and sound playback functions as the electronic unit (101, FIG. 1) described above in connection with the baby bottle (100, FIG. 1).

In the illustrated example, the toddler cup (150) is a plastic cup design with a fully enclosed cup bottom roughly 3½ inches in depth and 2⅜ inches wide at the base. The cup (150) has an additional ½ inch extension below the bottom (156) on which are disposed screw threads around the cup base for attaching the electronic unit (155). This extension is 2¼ inches wide.

The top of the cup (150) may be configured to allow the lid (151) to snap in place or may include, for example, a ¾″ inch extension with screw threads with which the lid (151) is screwed onto the cup (150). This brings the total plastic cup height to roughly 4¾ inches.

As indicated above, in some examples, the drinking spout (152) may be replaced with a molded plastic nipple in a cap screw lid that measures ¾ inches high by 2⅞ wide. The nipple may be, for example, 1 inch high and disposed on one side of the lid, brining the total cup height to roughly 5¾ inches without the electronic unit (155) being attached. The electronic unit (155) measures, in the illustrated example, 2⅜ inches wide by 1 inch high, bringing the total cup height with the electronic unit (155) attached to roughly 6¼ inches.

Again, all dimensions given herein are merely exemplary. The cup (150) or other drinking vessel described may be formed to any dimensions desired.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A drinking vessel comprising:
a vessel for containing a liquid; and
an electronic unit for attachment to said vessel;
wherein said electronic unit is configured to emit both light and sound.

2. The drinking vessel of claim 1, wherein said drinking vessel is a baby bottle.

3. The drinking vessel of claim 1, wherein said drinking vessel is a toddler cup.

4. The drinking vessel of claim 1, wherein said electronic unit further comprises a memory unit for storing sound recordings for playback.

5. The drinking vessel of claim 4, wherein said electronic unit further comprises an interface for inputting sound recordings to said memory unit.

6. The drinking vessel of claim 5, wherein said interface comprises a wireless interface.

7. The drinking vessel of claim 5, wherein said interface is configured for connection to a computer.

8. The drinking vessel of claim 1, wherein said electronic unit comprises a light bulb for emitting said light.

9. The drinking vessel of claim 1, wherein said electronic unit comprises at least one light emitting diode for emitting said light.

10. The drinking vessel of claim 4, wherein said electronic unit further comprises a microphone for recording sounds on said memory unit for playback.

11. The drinking vessel of claim 1, further comprising a timer for automatically shutting off said light or said sound after a specified period of time.

12. The drinking vessel of claim 1, wherein said vessel is at least partially translucent and light from said electronic unit is diffused by said vessel and liquid in said vessel.

13. The drinking vessel of claim 1, wherein said electronic unit and said vessel each comprise threads so that said electronic unit can be screwed onto said vessel.

14. The drinking vessel of claim 1, wherein said electronic unit further comprises user controls for controlling said light and sound.

15. The drinking vessel of claim 14, wherein said user controls are configured to control recording of sounds for playback by said electronic unit.

16. The drinking vessel of claim 14, wherein said user controls are configured to control a volume of said sound.

17. The drinking vessel of claim 14, wherein said user controls are configured to control a timer for automatically shutting off said light or said sound after a specified period of time.

18. An electronic unit configured for attachment to a drinking vessel, said unit comprising:
a speaker for emitting sounds;
a memory for storing recorded sounds for playback using said speaker; and
a housing containing said speaker and memory, said housing comprising means for attaching said housing to said drinking vessel.

19. The electronic unit of claim 18, further comprising a light source.

20. The electronic unit of claim 18, wherein said means for attaching said housing comprises threads for screwing said housing to said drinking vessel.

21. The electronic unit of claim 19, further comprising a microphone for recoding sounds using said memory.

22. The electronic unit of claim 19, further comprising an interface for electronically connecting said unit with another device for downloading audio data to said memory.

23. The electronic unit of claim 19, further comprising user controls for operating said electronic unit.

24. A drinking vessel comprising:
a vessel for containing a liquid; and
an electronic unit for attachment to said vessel, said electronic unit comprising means for emitting light and means for emitting sounds.
